(19) United States
(12) Patent Application Publication
(10) Pub. No.: US 2009/0053605 A1
(43) Pub. Date: Feb. 26, 2009

(54) ACTIVE MATERIAL OF NEGATIVE ELECTRODE FOR NON-AQUEOUS ELECTROLYTE BATTERY, METHOD OF MANUFACTURING ACTIVE MATERIAL OF NEGATIVE ELECTRODE FOR NON-AQUEOUS ELECTROLYTE BATTERY AND NON-AQUEOUS ELECTROLYTE BATTERY

(76) Inventors: Yasuhiro HARADA, Yokohama-shi (JP); Norio Takami, Yokohama-shi (JP); Hiroki Inagaki, Kawasaki-shi (JP); Tomokazu Morita, Funabashi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/194,691

(22) Filed: Aug. 20, 2008

(30) Foreign Application Priority Data
Aug. 23, 2007 (JP) 2007-216999

(51) Int. Cl. H01M 4/48; C01G 23/04

(52) U.S. Cl. 429/231.1; 423/598

(57) ABSTRACT

There is disclosed a negative electrode active material for a non-aqueous electrolyte battery, which comprises lithium titanium composite oxide represented by a general formula of: Li₂₊ₓTi₄O₉ (wherein x is 0≦x≦4). The lithium titanium composite oxide is exhibited a highest intensity peak of (002) crystal face at 2θ=10°±2°, a peak of (402) crystal face at 2θ=30°±2° and a peak of (020) crystal face at 2θ=48°±2° as measured by a powder X-ray diffractometer using Cu—Kα-ray source. A half band width of the highest intensity peak is 0.5°/2θ to 3°/2θ.

### CROSS-REFERENCE TO RELATED APPLICATIONS

This application is based upon and claims the benefit of priority from prior Japanese Patent Application No. 2007-216999, filed Aug. 23, 2007, the entire contents of which are incorporated herein by reference.

### BACKGROUND OF THE INVENTION

1. Field of the Invention

This invention relates to an active material of negative electrode for a non-aqueous electrolyte battery, to a method of manufacturing an active material of negative electrode for a non-aqueous electrolyte battery, to a non-aqueous electrolyte battery and to a battery pack.

2. Description of the Related Art

As well known, a non-aqueous electrolyte battery, represented by a lithium ion secondary battery, is designed to be charged and discharged by the movement of lithium ions between a negative electrode and a positive electrode. This non-aqueous electrolyte battery is now being studied and developed as a candidate for a high-energy density battery. Especially, this non-aqueous electrolyte battery is expected to be used as a power source for hybrid cars, electric cars, uniterruptive power supply of mobile telephone base stations, etc. The battery to be used in these applications is required to have special properties, which differ from high-energy density properties, such as quick charge/discharge properties and long term reliability.

The practical applicability of the non-aqueous electrolyte battery which is capable of realizing quick charging/discharging not only makes it possible to remarkably reduce the time required for charging, but also makes it possible to improve the power performance of hybrid cars, etc. and to effectively recover the regenerative energy of motive power.

In the case of the non-aqueous electrolyte battery, the quick movement of electrons and lithium ions between the positive electrode and the negative electrode is important in order to realize quick charging/discharging. In the case of the lithium ion secondary battery where the conventional carbon-based negative electrode is employed, when the quick charging/discharging of a battery is repeated, the dendrite deposition of metallic lithium is caused to generate on the electrodes, thus giving rise to the heat build-up or ignition of battery due to the internal short-circuit.

In view of such problems, it is now attracting much attention to employ a metal composite oxide as a lithium host of negative electrode. Especially, titanium oxide among these metal oxides has been noticed as having properties that it makes it possible to execute stable quick charging/discharging due to the electric potential characteristics thereof and that the negative electrode containing the titanium oxide as an active material is longer in useful life as compared with the conventional carbon materials. However, since the titanium oxide of the conventional type is higher in electric potential with respect to metallic lithium and, at the same time, is lower in capacity density per weight as compared with the ordinary carbon-based negative electrode, the energy density, which is a key for the secondary battery, is inevitably lowered. For example, in the case of the conventional anatase-type titanium oxide, the theoretical capacity thereof is about 165 mAh/g, and even in the case of lithium titanium composite oxide such Li₄Ti₅O₁₂, the theoretical capacity thereof is about 180 mAh/g. Because of these facts, these conventional titanium oxides are known as being inferior in capacity density as compared with the ordinary graphite-type negative electrode materials having a theoretical capacity of 385 mAh/g or so. Owing to the specific crystal structure, many of these conventional compounds are limited in equivalent site for absorbing lithium and configured so as to enable lithium to stabilize in the crystal structure, the substantial capacity of these compounds is caused to reduce.

Meanwhile, due to the oxidation-reduction reaction between Ti³⁺ and Ti⁴⁺ on the occasion of electrochemically inserting and releasing lithium, the electrode potential of titanium oxides is caused to generate about 1.5V as measured based on metallic lithium. Because of this, the electrode potential of titanium oxides is electrochemically restricted on the occasion of performing the absorption and desorption of lithium by making use of the oxidation-reduction of titanium. Further, since the quick charging/discharging of lithium ions can be stably executed under the conditions where the electrode potential is as high as 1.5V or so, it is practically difficult to lower the electrode potential in an attempt to improve the energy density.

### BRIEF SUMMARY OF THE INVENTION

According to a first aspect of the present invention, there is provided an active material of a negative electrode for a non-aqueous electrolyte battery, which comprises lithium titanium composite oxide represented by a general formula of: Li₂₊ₓTi₄O₉ (wherein x is 0≦x≦4), the lithium titanium composite oxide being exhibited a highest intensity peak of (002) crystal face at 2θ=10°±2° (8°≦2θ≦12°), a peak of (402) crystal face at 2θ=30°±2° (28°≦2θ≦32°) and a peak of (020) crystal face at 2θ=48°±2° (46°≦2θ≦50°) as measured by a powder X-ray diffractometer using Cu—Kα-ray source, and a half band width of the highest intensity peak being 0.5°/2θ to 3°/2θ.

According to a second aspect of the present invention, there is provided a method of manufacturing an active material of a negative electrode for a non-aqueous electrolyte battery, which comprises:

pulverizing potassium titanate to obtain potassium titanate powder having an average particle diameter of 0.1 to 5 μm;

subjecting the potassium titanate powder to a reaction with an acid to exchange potassium ion with proton, thereby producing a proton-exchanged powder; and

subjecting the proton-exchanged powder to a reaction with a lithium compound to exchange the proton with lithium, thereby producing lithium titanium composite oxide represented by a general formula of: Li₂₊ₓTi₄O₉ (wherein x is 0≦x≦4), the lithium titanium composite oxide being exhibited a highest intensity peak of (002) crystal face at 2θ=10°±2° (8°≦2θ≦12°), a peak of (402) crystal face at 2θ=30°±2° (28°≦2θ≦32°) and a peak of (020) crystal face at 2θ=48°±2° (46°≦2θ≦50°) as measured by a powder X-ray diffractometer using Cu—Kα-ray source, and a half band width of the highest intensity peak being 0.5°/2θ to 3°/2θ.

According to a third aspect of the present invention, there is provided a non-aqueous electrolyte battery comprising:

a positive electrode which is capable of absorbing and desorbing lithium;

a negative electrode comprising an active material containing lithium titanium composite oxide represented by a general formula of: Li₂₊ₓTi₄O₉ (wherein x is 0≦x≦4), the lithium titanium composite oxide being exhibited a highest intensity peak of (002) crystal face at 2θ=10°±2° (8°≦2θ≦12°), a peak of (402) crystal face at 2θ=30°±2° (28°≦2θ≦32°) and a peak of (020) crystal face at 2θ=48°±2° (46°≦2θ≦50°) as measured by a powder X-ray diffractometer using Cu—Kα-ray source, and a half band width of the highest intensity peak being 0.5°/2θ to 3°/2θ; and

a non-aqueous electrolyte.

### BRIEF DESCRIPTION OF THE SEVERAL VIEWS OF THE DRAWING

FIG. 1 is a cross-sectional view schematically illustrating a flat type non-aqueous electrolyte battery according to a third embodiment;

FIG. 2 is an enlarged cross-sectional view illustrating the portion “A” of FIG. 1;

FIG. 3 is a partially cut perspective view schematically illustrating a flat type non-aqueous electrolyte battery according to a third embodiment;

FIG. 4 is an enlarged cross-sectional view illustrating the portion “B” of FIG. 3;

FIG. 5 is an exploded perspective view illustrating a battery pack according to a fourth embodiment;

FIG. 6 is a block diagram illustrating an electric circuit of the battery pack shown in FIG. 5; and

FIG. 7 is a powder X-ray diffraction pattern, as obtained by making use of Cu—Kα-ray, of lithium titanium composite oxide powder which was obtained in Synthesis method 1.

### DETAILED DESCRIPTION OF THE INVENTION

Next, an active material of a negative electrode for a non-aqueous electrolyte battery, a manufacturing method of an active material of a negative electrode for a non-aqueous electrolyte battery, a non-aqueous electrolyte battery and a battery pack according to the embodiments of the present invention will be explained with reference to drawings. Incidentally, throughout these embodiments, the same components will be identified by the same reference numbers thereby avoiding the repeated explanation thereof. Further, these drawings are schematic views which are simply intended to explain the present invention and to facilitate the understanding of the present invention. Therefore, the configuration, dimension and relative ratio in size of these devices may differ from actual devices. These constituent components may be optionally modified in design by taking the following explanation and known technologies into consideration.

### First Embodiment

An active material of a negative electrode for a non-aqueous electrolyte battery according to this first embodiment comprises lithium titanium composite oxide represented by a general formula of: Li₂₊ₓTi₄O₉ (wherein x is 0≦x≦4). The lithium titanium composite oxide is exhibited a highest intensity peak of (002) crystal face at 2θ=10°±2°, a peak of (402) crystal face at 2θ=30°±2° and a peak of (020) crystal face at 2θ=48°±2° as measured by a powder X-ray diffractometer using Cu—Kα-ray source. A half band width of the highest intensity peak exhibited the lithium titanium composite oxide is 0.5°/2θ to 3°/2θ.

If the half band width of the highest intensity peak is less than 0.5°/2θ, the crystallizability of lithium titanium composite oxide would become higher, thus possibly deteriorating the charge/discharge capacity. On the other hand, if the half band width exceeds 3°/2θ, the crystallizability of lithium titanium composite oxide would become very low, thus possibly resulting in the deterioration of repeated charge/discharge properties. A more preferable range of the half band width of the highest intensity peak is 1°/2θ to 2°/2θ.

The specific surface area of lithium titanium composite oxide should preferably be not less than 200 m²/g to 400 m²/g as measured by the BET method. If the specific surface area exceeds 400 m²/g, the crystallizability of lithium titanium composite oxide would become lower, and possibly increasing a reaction between lithium titanium composite oxide and an electrolyte.

Herein, the method of measuring the specific surface area can be used the following a method. That is, a molecule whose occupied area of adsorption is already known, is allowed to adsorb onto the surface of a powdery particle as a sample at the temperature of liquid nitrogen to measure the quantity of the molecules. The specific surface area of the sample is determined by the quantity of the molecules. The most popular method of measuring the specific surface area is the BET method, which utilizes the low temperature/low humidity physical adsorption of an inert gas. A calculation method of the specific surface area is used a famous theory in which the Langmuir theory as a monomolecular layer adsorption theory is extended to multimolecular layer adsorption. The specific surface area determined in this manner is called “BET specific surface area”. Using this theory, it is assumed that molecules can be adsorbed in an infinitely laminated state and that there is no interaction between adsorbed layers, so that the Langmuir formula is valid for each layer. This BET formula can be represented by the following formula (1).

$$\frac{P}{V ( {P}_{0} - P )} = ( \frac{C - 1}{{V}_{m} C} ) ( \frac{P}{{P}_{0}} ) + \frac{1}{{V}_{m} C} \qquad ( 1 )$$

wherein P is an adsorption equilibrium pressure as measured in a state of adsorption equilibrium under a constant temperature; P₀ is a saturated vapor pressure at an adsorption temperature; V is a quantity of adsorption at the adsorption equilibrium pressure P; Vₘ is a quantity of monomolecular layer adsorption (a quantity of adsorption as a monomolecular layer is formed by gas molecules on the surface of solid matter); and C is a BET constant (a parameter related to the interaction between the surface of solid matter and an adsorbate).

The aforementioned relationship is quite valid in the case where P/P₀ is confined to the range of 0.05 to 0.35. When this formula (1) is modified (the numerator and denominator on the left side are both divided by P), the following formula (2) can be obtained.

$$\frac{1}{V ( \frac{{P}_{0}}{P} - 1 )} = ( \frac{C - 1}{{V}_{m} C} ) ( \frac{P}{{P}_{0}} ) + \frac{1}{{V}_{m} C} \qquad ( 2 )$$

In the employment of a specific surface area-measuring instrument, a molecule whose occupied area of adsorption is already known is allowed to adsorb onto the surface of sample to obtain the quantity of adsorption (V) and then the relationship between the quantity of adsorption (V) and the relative pressure (P/P₀) is determined. Based on V and P/P₀ thus measured, when the components on the left side of formula (2) and P/P₀ are plotted, a linear relationship can be obtained. When the gradient thereof is represented by “s”, the following formula (3) can be obtained from the formula (2). When the intercept in the equality (3) is represented by “i”, the following formula (4) can be obtained and “s” can be represented by the following formula (5).

$$\begin{matrix}s = \frac{C - 1}{{V}_{m} C} = \frac{C}{{V}_{m} C} - \frac{1}{{V}_{m} C} = \frac{1}{{V}_{m}} - \frac{1}{{V}_{m} C} & ( 3 ) \\ i = \frac{1}{{V}_{m} C} & ( 4 ) \\ s = \frac{1}{{V}_{m}} - i & ( 5 )\end{matrix}$$

Namely, the quantity of monomolecular layer adsorption Vₘ can be determined by measuring the quantity of adsorption V at a certain relative pressure P/P₀ at several points and then by determining the inclination of the plots and the intercept. Therefore, a total surface area of a sample can be determined according to the following formula (6).

Sₜₒₜₐₗ=(Vₘ×N×A_{cs})M (6)

wherein Sₜₒₜₐₗ is a total surface area (m²); Vₘ is a quantity of monomolecular layer adsorption (−); N is Avogadro's number; A_{cs} is a sectional area of adsorption (m²); and M is a molecular weight (−)

The specific surface area can be determined from the total surface area according to the following formula (7).

S=Sₜₒₜₐₗ/W (7)

Wherein S is a specific surface area (m²/g); and w is a quantity (g) of sample.

The active material of the negative electrode according to the first embodiment may be formed of a mixture in which two or more kinds of lithium titanium composite oxides having the aforementioned characteristics are mixed together.

According to the first embodiment explained above, it is possible to provide an active material of a negative electrode for a non-aqueous electrolyte battery, which is capable of exhibiting an electrode potential of nearly 1.5V (based on lithium) which is almost equivalent to that of the conventional titanate-based materials and also exhibiting a higher energy density as compared with the conventional titanate-based materials.

Namely, the lithium titanium composite oxide which is represented by a general formula of: Li₂₊ₓTi₄O₉ (wherein x is 0≦x≦4), exhibiting three peaks at three characteristic crystal face indics, i.e. a highest intensity peak of (002) crystal face, a peak of (402) crystal face and a peak of (020) crystal face as measured by a powder X-ray diffractometer using Cu—Kα-ray source and a half band width of the highest intensity peak being a specific range, is featured in that the crystal structure thereof is constituted by a two-dimensional layer structure. More specifically, this lithium titanium composite oxide has the stable skeletal structures which are constituted by titanium ion and oxide ion, respectively, and are alternately two-dimensionally arranged. A space to be utilized as a host for lithium ions is formed at each interlayer portion thereof. Namely, as the lithium titanium composite oxide powder is viewed through from a certain angle, equivalent insertion spaces for lithium ion can be increased and, at the same time, this insertion spaces are structurally stable. Because of this, the insertion/desorption properties of lithium ions to these spaces can be enhanced and, still more, the insertion/release spaces for the lithium ion can be effectively and substantially increased, thus making it possible to increase the capacity of the negative electrode.

Due to this substantial increase of the insertion/desorption spaces for the lithium ion, the efficiency of reduction from Ti⁴⁺ constituting a skeleton as the lithium ion is inserted into the aforementioned spaces to Ti³⁺ can be improved, thus making it possible to maintain the electric neutrality of the crystal. As a result, this lithium titanium composite oxide is enabled to have four Ti⁴⁺ per unit lattice, so that, theoretically speaking, four Li⁺, at maximum, can be inserted into these interlayer spaces.

For this reason, the lithium titanium composite oxide, which is represented by a general formula of: Li₂₊ₓTi₄O₉ (wherein x is 0≦x≦4) and has a two-dimensional layer structure in terms of crystal structure, is enabled to increase the theoretical capacity thereof up to 307 mAh/g which is nearly twice as large as the conventional titanium oxide.

The non-aqueous electrolyte battery comprising the negative electrode contained the lithium titanium composite oxide according to the first embodiment is capable of exhibiting an electrode potential of nearly 1.5V (based on lithium) which is almost equivalent to that of the conventional titanate-based materials, and also exhibits a higher energy density as compared with the conventional titanate-based materials.

Especially, the lithium titanium composite oxide having a specific surface area of not less than 200 m²/g as measured based on the BET method is enabled to increase not only the contacting surface thereof with an electrolyte but also the host site to which lithium ion can be inserted and desorbed on the occasion of charging/discharging, for instance, thus enabling a much higher quantity of lithium ions to move quickly into the host site. For this reason, it is possible to further enhance the quick charging/discharging properties of the battery and also to enhance the electrode capacity.

### Second Embodiment

A method of manufacturing an active material (lithium titanium composite oxide) of a negative electrode for a non-aqueous electrolyte battery according to the second embodiment will be explained in detail as follows.

First of all, potassium titanate is pulverized to obtain potassium titanate powder having an average particle diameter of 0.1 to 5 μm.

The potassium titanate can be used not only the potassium titanate that can be synthesized by means of a flux method, for example, but also the potassium titanate that is ordinarily available in the market as a reagent.

The step of pulverization should preferably be performed by using a potassium titanate material which has been washed with pure water to remove impurities and then dried. More specifically, the pulverization should preferably be performed using a vessel charged with zirconia balls having a diameter of 10 to 15 mm and contained in the vessel at a ratio of one per 100 cm³ in volume of the vessel and under the conditions wherein the vessel is rotated at rate of 600 to 1000 rpm for 1 to 3 hours. If the treating time period using this ball mill is less than one hour, the potassium titanate powder to be obtained would become such that the average particle diameter thereof is not more than 10 μm but more than 5 μm or so, thus failing to sufficiently pulverize the potassium titanate and making it difficult to obtain a lithium titanium composite oxide having a high specific surface area. On the other hand, if this pulverization treatment is continued for a long time, exceeding 3 hours, a mechanochemical reaction may be caused to take place, thus permitting the phase separation of potassium titanate to take place and creating compounds which differ from the target product.

When the average particle diameter of potassium titanate powder after the pulverization is larger than 5 μm, it may be impossible to sufficiently execute the subsequent proton exchange, thus possibly permitting potassium to be left behind as an impurity in the end product. More preferably, the average particle diameter of the potassium titanate powder after the pulverization is the range of 0.1 to 1 μm.

Then, the potassium titanate powder thus pulverized is reacted with an acid such as hydrochloric acid, sulfuric acid, nitric acid, thereby exchanging potassium ion with proton.

The proton exchange by way of acid treatment can be performed in such a manner that hydrochloric acid 1M in concentration, for example, is added to potassium titanate powder and then the resultant mixture is stirred. For the purpose of adjusting the pH of solution, an alkaline solution may be added to the mixture on the occasion of the proton exchange. The surface of potassium titanate powder may be roughened on the occasion of this proton exchange, thus increasing the specific surface area of potassium titanate powder up to about 200 m²/g to about 300 m²/g.

Thereafter, the resultant proton-exchanged powder is washed again using pure water. Since this proton-exchanged powder is made higher in specific surface area at this moment, the separation thereof from a washing solvent (pure water) should preferably be conducted using a centrifugal separator. Then, the proton-exchanged powder thus water-washed is added to and stirred with an aqueous solution of lithium compound to carry out the reaction between the proton-exchanged powder and the lithium compound, thus enabling to exchange the proton with lithium. In this manner, it is possible to manufacture the lithium titanium composite oxide. This lithium titanium composite oxide is represented by a general formula of: Li₂₊ₓTi₄O₉ (wherein x is 0≦x≦4). The lithium titanium composite oxide exhibits a highest intensity peak of (002) crystal face at 2θ=10°±2θ, a peak of (402) crystal face at 2θ=30°±2° and a peak of (020) crystal face at 2θ=48°±2° as measured by a powder X-ray diffractometer using Cu—Kα-ray source. A half band width of the highest intensity peak is 0.5°/2θ to 3°/2θ.

Although examples of the lithium compound are not any particular limitation, it is preferable to employ lithium chloride or lithium hydroxide, because the exchanging the proton of proton-exchanged powder for lithium can be easily executed by making use of these compounds.

During the aforementioned reaction, use of an aqueous lithium chloride solution or an aqueous lithium hydroxide solution with a fresh would be preferable since the exchanging the proton with lithium can be promoted.

The resultant product (lithium titanium composite oxide) is then subjected to washing with water and drying. Since this product contains crystal water, it may be subjected to a thermal dehydration treatment at a temperature of 400 to 800° C.

According to the manufacturing method of the second embodiment, since potassium titanate is pulverized so as to have an average particle diameter of 0.1 to 5 μm prior to the step of proton exchange, the proton exchange of potassium titanate powder can be reliably performed without leaving behind potassium as an impurity in the lithium titanium composite oxide. Therefore, it is now possible to manufacture a lithium titanium composite oxide which is capable of exhibiting an electrode potential of nearly 1.5V (based on lithium), which is almost equivalent to that of the conventional titanate-based materials, and also exhibiting not only a higher energy density as compared with the conventional titanate-based materials but also a high specific surface area, e.g. a specific surface area of 200 m²/g to 400 m²/g as measured based on the BET method, for instance.

### Third Embodiment

The non-aqueous electrolyte battery according to a third embodiment is equipped with an outer case. The positive electrode, the negative electrode and the separator are all placed inside this outer case. A non-aqueous electrolyte is also accommodated in this outer case.

Next, details of the outer case, the negative electrode, the non-aqueous electrolyte and the separator will be discussed as follows.

1) Outer Case

The outer case is formed of a laminate film having a thickness of not more than 0.5 mm or a metallic vessel having a thickness of not more than 1.0 mm. More preferably, the thickness of the metallic vessel is 0.5 mm or less.

The configuration of the outer case may be a flat type (thin type), a square type, a cylindrical type, a coin type or a button type. This outer case may be variously designed depending on the size thereof. For example, it can be designed as an outer case for a small battery which can be mounted, for example, on mobile electronic instruments, or as an outer case for a large battery which can be mounted, for example, on a two-wheeled vehicle or a four-wheeled vehicle.

The laminate film can be used as a multi-layer film having a metal layer interposed between resin films. The metal layer is preferably formed of aluminum foil or aluminum alloy foil for reducing the weight thereof. The resin film can be used, for example, polypropylene (PP), polyethylene (PE), nylon, polyethylene terephthalate (PET). The laminate film can be molded into any desired configuration of outer case through sealing using thermal fuse-bonding.

The metal vessel can be manufactured from aluminum or aluminum alloys. The aluminum alloys is preferable to select from alloys containing magnesium, zinc, silicon. If aluminum alloys contain a transition metal such as iron, copper, nickel, chromium, the quantity thereof is preferably not more than 100 ppm.

2) Negative Electrode

The negative electrode comprises a current collector, and a negative electrode layer (negative electrode active material-containing layer) formed on one or both surfaces of the current collector and containing an active material, a conductive agent and a binder. In this negative electrode layer, the gaps formed among the dispersed active material are filled with the binder and a conductive agent is incorporated therein for improving the collecting performance and for suppressing the contact resistance thereof with respect to the current collector.

The active material comprises lithium titanium composite oxide represented by a general formula of: Li₂₊ₓTi₄O₉ (wherein x is 0≦x≦4). The lithium titanium composite oxide exhibits a highest intensity peak of (002) crystal face at 2θ=10°±2°, a peak of (402) crystal face at 2θ=30°±2° and a peak of (020) crystal face at 2θ=48°±2° as measured by a powder X-ray diffractometer using Cu—Kα-ray source. A half band width of the highest intensity peak is 0.5°/2θ to 3°/2θ. This lithium titanium composite oxide has preferably a specific surface area of not less than 200 m²/g as measured based on the BET method.

The conductive agent can be used, for example, carbonaceous materials such as acetylene black, carbon black, graphite.

Examples of the binder include polytetrafluoroethylene (PTFE), poly(vinylidene fluoride), fluorinated rubber, styrene butadiene rubber.

The mixing ratio of the binder in the negative electrode is preferably the range of 2 to 30 wt %. If the mixing ratio of the binder is less than 2 wt %, the bonding strength between the negative electrode layer and the current collector would be decreased, thereby possibly deteriorating the cycle characteristics of the battery. On the other hand, in viewpoint of increasing the capacity of the battery, the mixing ratio of the binder is not more than 30 wt %. The conductive agent is preferably incorporated in the negative electrode at a ratio of not more than 30 wt %.

The current collector can be used a material which is electrochemically stable at the absorbing/desorbing potential of lithium of the active material. For example, the current collector is preferably made of copper, nickel, stainless steel or aluminum. The thickness of the current collector is preferably the range of 5 to 20 μm. The current collector having this range of thickness is well balanced with respect to the strength and weight-saving of the negative electrode.

In the manufacture of the negative electrode, the active material, the conductive agent and the binder are suspended in a common solvent to prepare a slurry. Then, the slurry is coated on the surface of a current collector and dried to form a negative electrode layer, which is then pressed to manufacture the negative electrode. Alternatively, a mixture consisting of the active material of the negative electrode, the conductive agent and the binder may be formed into pellets for using them to form the negative electrode layer.

3) Non-Aqueous Electrolyte

Examples of the non-aqueous electrolyte include a liquid non-aqueous electrolyte which can be prepared by dissolving an electrolyte in an organic solvent, and a gel-like non-aqueous electrolyte which can be obtained by making a liquid electrolyte and a macromolecular material into a composite configuration.

The liquid non-aqueous electrolyte can be prepared by dissolving an electrolyte in an organic solvent at a concentration of 0.5 mol/L to 2.5 mol/L.

Examples of the electrolyte include lithium salts such as lithium perchlorate (LiClO₄), lithium phosphate hexafluoride (LiPF₆), lithium borate tetrafluoride (LiBF₄), lithium arsenate hexafluoride (LiAsF₆), lithium trifluorometasulfonate (LiCF₃SO₃), bistrifluoromethyl sulfonyliminolithium [LiN(CF₃SO₂)₂], and a mixture thereof. It is preferable to employ those which do not oxidize even at high electric potentials. Among them, LiPF₆ is most preferable.

Examples of the organic solvent include cyclic carbonates such as propylene carbonate (PC), ethylene carbonate (EC) and vinylene carbonate; linear carbonates such as diethylene carbonate (DEC), dimethylene carbonate (DMC) and methylethyl carbonate (MEC); cyclic ethers such as tetrahydrofuran (THF), 2-methyl tetrahydrofuran (2Me THF) and dioxorane (DOX); linear ethers such as dimethoxy ethane (DME) and diethoxy ethane (DEE); and γ-butyrolactone (GBL); acetonitrile (AN); sulforane (SL). These solvents can be used singly or in combination of two or more kinds.

The macromolecular materials can be used, for example, as poly(vinylidene fluoride)(PVdF), polyacrylonitrile (PAN), polyethylene oxide (PEO), etc.

Incidentally, the non-aqueous electrolyte may be selected from cold melting salts (ionic melt) containing lithium, macromolecular solid electrolytes containing lithium, and inorganic solid electrolytes containing lithium.

The cold melting salts (ionic melt) are compounds selected from organic salts formed of a combination of an organic cation and anion that exist in a liquid state at ordinary temperatures (15° C. to 25° C.). Examples of cold melting salts are salts that exist in a liquid state as a simple substance, salts that exist in a liquid state only when mixed with an electrolyte, and salts that exist in a liquid state only when dissolved in an organic solvent. Incidentally, the melting point of the cold melting salts that can be employed in the non-aqueous electrolyte battery is generally confined to not higher than 25° C. Further, the organic cation is generally selected from those having a quaternary ammonium skeleton.

The macromolecular solid electrolytes can be prepared by a method wherein an electrolyte is dissolved in a macromolecular material and then solidified.

The inorganic solid electrolytes are formed of a solid substance having lithium ion-conducting properties.

4) Positive Electrode

The positive electrode comprises a current collector, and a positive electrode layer (positive electrode active material-containing layer) formed on one or both surfaces of the current collector and containing an active material and a binder.

The active material can be used, for example, as oxides or sulfides. Examples of the active material include manganese dioxide (MnO₂), iron oxide, copper oxide, nickel oxide, lithium manganese composite oxides (for example, LiₓMn₂O₄ or LiₓMnO₂), lithium nickel composite oxides (for example, LiₓNiO₂), lithium cobalt composite oxides (for example, LiₓCoO₂), lithium nickel cobalt composite oxides (for example, LiNi_{1-y}Co_{y}O₂), lithium manganese cobalt composite oxides (for example, LiₓMn_{y}Co_{1-y}O₂), spinel type lithium manganese nickel composite oxides (for example, LiₓMn_{2-y}Ni_{y}O₄), lithium phosphorus oxide of olivine structure (for example, LiₓFePO₄, LiₓFe_{1-y}Mn_{y}PO₄, LiₓCoPO₄), iron sulfate (Fe₂(SO₄)₃, vanadium oxide (for example, V₂O₅). Herein x and y are preferably 0<x≦1 and 0<y≦1. The manganese dioxide, the iron oxide, the copper oxide, the nickel oxide, the iron sulfate and the vanadium oxide are lithium-ion intercalation compounds, respectively.

As for examples of the positive electrode active material which is capable of obtaining a high positive electrode voltage, they include lithium manganese composite oxides (LiₓMn₂O₄), lithium nickel composite oxides (LiₓNiO₂), lithium cobalt composite oxides (LiₓCoO₂), lithium nickel cobalt composite oxides (LiNi_{1-y}Co_{y}O₂), spinel type lithium manganese nickel composite oxides (LiₓMn_{2-y}Ni_{y}O₄), lithium manganese cobalt composite oxides (LiₓMn_{y}Co_{1-y}O₂), lithium iron phosphate (LiₓFePO₄), and lithium nickel cobalt manganese composite oxide. Herein x and y are preferably 0<x≦1 and 0<y≦1.

Among them, when a non-aqueous electrolyte containing cold melting salts is used, the use of lithium iron phosphate, LiₓVPO₄F, lithium manganese composite oxides, lithium nickel composite oxides and lithium nickel cobalt composite oxides is more preferable in viewpoint of the increasing of the charge/discharge cycle life. The reason for this is that the reaction between the active material and the cold melting salt can be minimized by the use of these active materials.

Preferably, the primary particle diameter of the active material is the range of 100 nm to 1 μm. By doing so, the handling of the active material would become easier in the industrial production. Further, the use of the active material having a primary particle diameter of not more than 1 μm is advantageous in smoothly proceeding the inter-solid diffusion of lithium ion.

Preferably, surface area of the active material is the range of 0.1 to 10 m²/g. Such the active material having a specific surface area of not less than 0.1 m²/g is advantageous in sufficiently securing the occlusion/desorption site of lithium ions. In addition, such the active material having a specific surface area of not more than 10 m²/g is advantageous in facilitating the handling thereof in the industrial production, and, at the same time, in securing excellent charge/discharge cycle performance of a battery.

The binder is designed to bond the positive electrode layer with the current collector. The binder can be used, for example, as polytetrafluoroethylene (PTFE), poly(vinylidene fluoride), fluorinated rubber, etc.

A conductive agent can be incorporated, as required, in the positive electrode in order to enhance the electronic collecting performance and to suppress the contact resistance of active material to the current collector. Examples of the conductive agent include carbonaceous materials such as acetylene black, carbon black, and graphite.

The mixing ratio between the active material and the binder is preferably 80 to 98 wt % of the active material and 2 to 20 wt % of the binder. When the binder is incorporated at a mixing ratio of not less than 2 wt %, it is possible to secure a sufficient strength of the electrode. When the mixing ratio of binder is not more than 20 wt %, it is possible to decrease the mixing ratio of the insulating material in the positive electrode layer and to decrease the internal resistance of the positive electrode layer.

When the conductive agent is used in the manufacturing of the positive electrode, the use thereof at a ratio of not less than 3 wt % would be effective in enabling the conductive agent to exhibit its intended effects. When the mixing ratio of the conductive agent is not more than 15 wt %, it is possible to minimize the decomposition of non-aqueous electrolyte on the surface of conductive agent even in the storage under high temperatures.

In the manufacture of the positive electrode, the active material, the binder and, if required, the conductive agent are suspended in a suitable solvent to prepare a slurry. Then, the slurry is coated on the surface of a current collector and dried to form a positive electrode layer, which is then pressed to manufacture the positive electrode.

Alternatively, a mixture comprising the active material, the conductive agent and the binder may be formed into pellets for using them to form the positive electrode layer.

The current collector is preferably formed of aluminum foil or aluminum alloy foil.

The thickness of aluminum foil or aluminum alloy foil is preferably 5 μm to 20 μm, more preferably 1.50 μm or less. Further, it is desirable that the aluminum foil has a purity of 99% or more. The aluminum alloys may preferably be selected from alloys containing magnesium, zinc, silicon. If aluminum alloys contains a transition metal such as iron, copper, nickel, chromium, the quantity thereof is preferably not more than 1% by weight.

5) Separator

The separator can be used, for example, as a porous film formed of polyethylene, polypropylene, cellulose or polyvinylidene fluoride (PVdF); and unwoven fabrics formed of synthetic resin. Among them, a porous film formed of polyethylene or polypropylene is preferable, since it is capable of being fused at a predetermined temperature, thereby cutting of electric current between the negative and positive electrodes. Thus, this porous film is preferable in viewpoints of enhancing the safety.

The electrode group comprising the aforementioned negative electrodes, positive electrodes and separators may be configured into a laminate structure other than a wound structure.

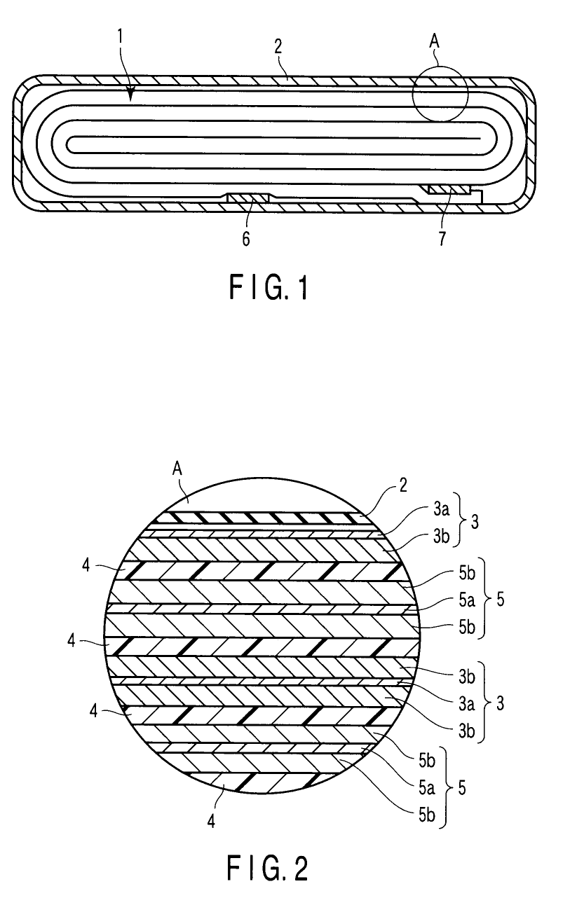

Next, the non-aqueous electrolyte battery according to the third embodiment will be explained in detail with reference to FIGS. 1 and 2. FIG. 1 is a cross-sectional view schematically illustrating a flat type non-aqueous electrolyte secondary battery according to the third embodiment; and FIG. 2 is an enlarged cross-sectional view illustrating the portion “A” of FIG. 1.

A flattened wound electrode group 1 is housed in a bag-like outer case 2 which is formed from a laminate film comprising two resin films with a metal layer interposed between them. The flattened wound electrode group 1 is constructed such that a laminate comprising, mentioning from outside, a negative electrode 3, a separator 4, a positive electrode 5 and a separator 4 is spirally wound and press-molded to form the flattened wound electrode group 1. As shown in FIG. 2, the negative electrode 3 constituting the outermost husk comprises a current collector 3a, and a negative electrode layer 3b formed on an inner surface of the current collector 3a and containing lithium titanium composite oxide as an active material. Other negative electrodes 3 located inside comprise respectively the current collector 3a, and a negative electrode layer 3b formed on the opposite surfaces of the current collector 3a and containing lithium titanium composite oxide. The positive electrode 5 comprises a current collector 5a, and a positive electrode layer 5b formed on the opposite surfaces of the current collector 5a.

In the vicinity of the outer circumferential edge portion of the flattened wound electrode group 1, a negative electrode terminal 6 is electrically connected with the current collector 3a of the negative electrode 3 located the outermost husk and a positive electrode terminal 7 is electrically connected with the current collector 5a of the inner positive electrode 5. The negative electrode and positive electrode terminals 6 and 7 are led out through an opening of the bag-like outer case 2. For example, a liquid non-aqueous electrolyte is poured into the bag-like outer case 2 through the opening of the outer case 2. The opening of the bag-like outer case 2 is heat-sealed with the negative electrode terminal 6 and positive electrode terminal 7 being located inside, thereby completely sealing the flattened wound electrode group 1 and the liquid non-aqueous electrolyte.

The negative terminal can be made of materials which are electrochemically stable at a absorption/desorption potential of lithium in the active material of the negative electrode and are electrically conductive. Examples of the material for the negative electrode terminal include copper, nickel, stainless steel and aluminum. Preferably, the negative terminal is made of the same material as that of the current collector of negative electrode in order to minimize the contact resistance thereof to the current collector of the negative electrode.

The positive terminal can be made of materials which are excellent in electric stability under the condition where the electric potential of lithium ions to metal is the range of 3V to 5V and are electrically conductive. Examples of the material for the positive electrode terminal include aluminum and aluminum alloys containing any of elements such as Mg, Ti, Zn, Mn, Fe, Cu, Si. Preferably, the positive terminal is made of the same material as that of the current collector of the positive electrode in order to minimize the contact resistance thereof to the current collector of the positive electrode.

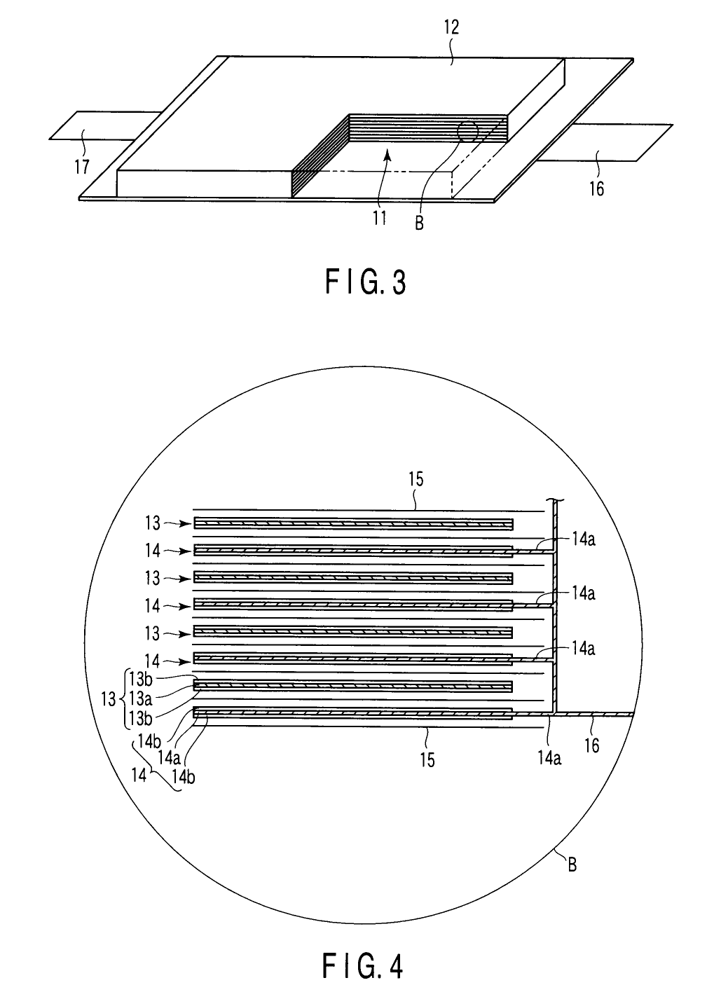

The non-aqueous electrolyte battery according to the third embodiment may be constructed, for example, as shown in FIGS. 3 and 4 without being limited to the construction shown in FIGS. 1 and 2. FIG. 3 is a partially cut perspective view schematically illustrating another flat type non-aqueous electrolyte secondary battery according to a third embodiment; and FIG. 4 is an enlarged cross-sectional view illustrating the portion “B” of FIG. 3.

A laminate type electrode group 11 is housed in an outer case 12 which is formed from a laminate film comprising two resin films with a metal layer interposed between them. The laminate type electrode group 11 has a laminate structure in which a positive electrode 13 and a negative electrode 14 with a separator 15 being interposed therebetween, are laminated with each other as shown in FIG. 4. In this laminate structure, a plurality of positive electrodes 13 are provided, each positive electrode 13 comprising a current collector 13a and two positive electrode layers 13b formed on the opposite surfaces of the current collector 13a. Likewise, a plurality of negative electrodes 14 are provided, each negative electrode 14 comprising a current collector 14a and two negative electrode layers 14b formed on the opposite surfaces of the current collector 14a. One side portion of the current collector 14a of each negative electrode 14 is protruded out of the positive electrode 13. This protruded portion of current collector 14a is electrically connected with a strip-like negative electrode terminal 16. A distal end portion of the strip-like negative electrode terminal 16 is extended outward from the outer case 11. Further, although not shown in the drawing, one side portion of the current collector 13a of the positive electrode 13, which is positioned opposite to the protruded side of the current collector 14a, is also protruded out of the negative electrode 14. The current collector 13a which is protruded out of the negative electrode 14 is electrically connected with a strip-like positive electrode terminal 17. A distal end portion of the strip-like positive electrode terminal 17 is positioned opposite to the negative electrode terminal 16 and extended outward from one sidewall of the outer case 11.

According to this third embodiment, since the non-aqueous electrolyte battery is provided with a negative electrode comprising an active material containing lithium titanium composite oxide which is capable of exhibiting an electrode potential of nearly 1.5V (based on lithium), which is almost equivalent to that of the conventional titanate-based materials as explained in the first embodiment and also exhibiting a higher energy density as compared with the conventional titanate-based materials, it is now possible to provide a non-aqueous electrolyte battery which enables stable repeated quick charge/discharge performance.

### Fourth Embodiment

The battery pack according to the fourth embodiment is provided with a plurality of the aforementioned non-aqueous electrolyte batteries (single cells), these single cells being electrically connected with each other in series or in parallel.

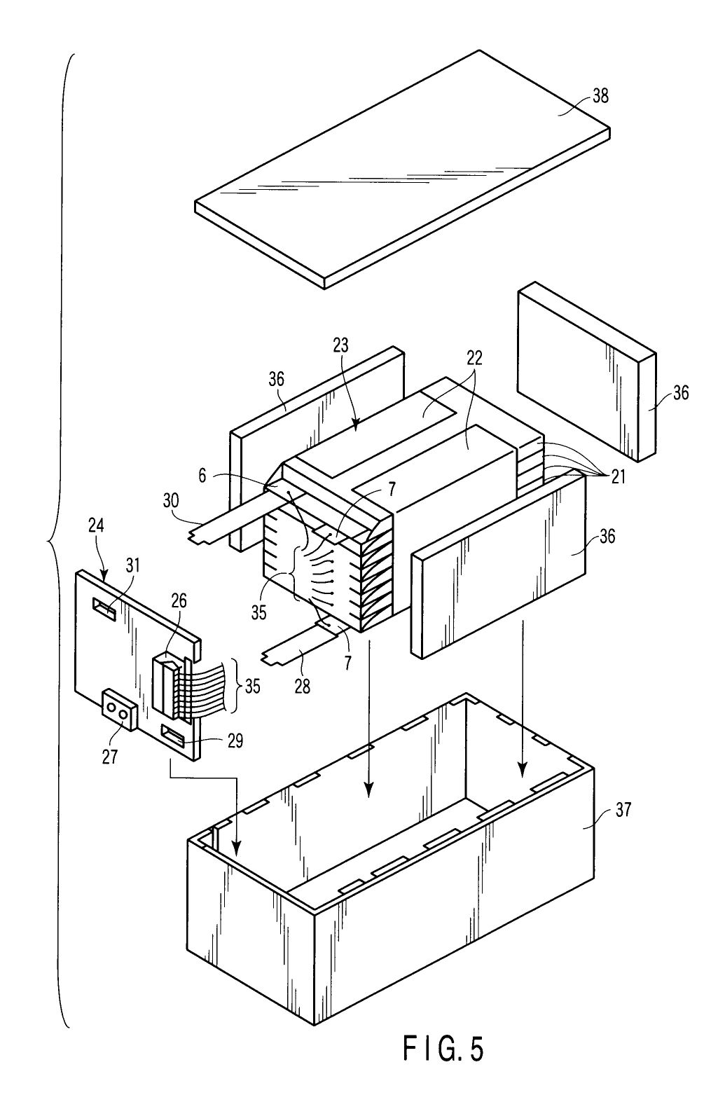

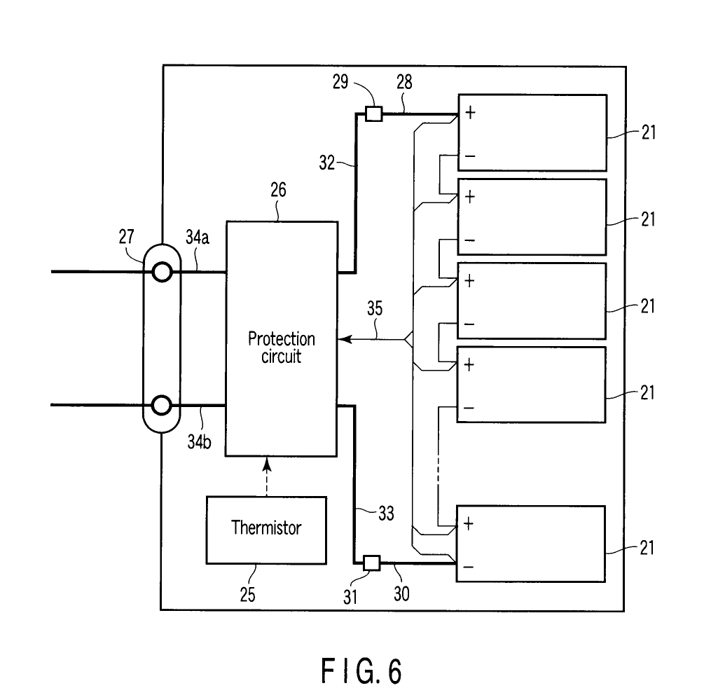

One example of such a battery pack will be explained in detail with reference to FIGS. 5 and 6. As for the single cell, it is possible to employ the flat type non-aqueous electrolyte secondary battery as shown in FIG. 1.

A plurality of single cells 21, each formed of the flatting type non-aqueous electrolyte secondary battery shown in FIG. 1, are laminated in such a manner that the negative electrode terminal 6 and the positive electrode terminal 7, both being externally led out, are arrayed to extend in the same direction and that they are clamped together by means of an adhesive tape 22, thereby creating a combined battery 23. These single cells 21 are electrically connected with each other in series as shown in FIG. 6.

A printed wiring board 24 is disposed to face the side wall of each of the single cells 21 where the negative electrode terminal 6 and the positive electrode terminal 7 are externally led out. On this printed wiring board 24 are mounted a thermistor 25, a protection circuit 26, and a terminal 27 for electrically connecting the printed wiring board 24 with external instruments. It should be noted that in order to prevent unwanted electric connection with the wirings of the combined battery 23, an insulating plate (not shown) is attached to the surface of the printed wiring board 24 that faces the combined battery 23.

A lead 28 for the positive electrode is electrically connected, through one end thereof, with the positive electrode terminal 7 which is located at the lowest layer of the combined battery 23. The other end of the lead 28 is inserted into and electrically connected with a connector 29 for the positive terminal of the printed wiring board 24. A lead 30 for the negative electrode is electrically connected, through one end thereof, with the negative electrode terminal 6 which is located at the highest layer of the combined battery 23. The other end of the lead 30 is inserted into and electrically connected with a connector 31 for the negative terminal of the printed wiring board 24. These connectors 29 and 31 are electrically connected, through interconnects 32 and 33 formed on the printed wiring board 24, with the protection circuit 26.

The thermistor 25 is used for detecting the temperature of single cells 21 and the signals thus detected are transmitted to the protection circuit 26. This protection circuit 26 is designed to cut off, under prescribed conditions, the wiring 34a of plus-side and the wiring 34b of minus-side which are interposed between the protection circuit 26 and the terminal 27 for electrically connecting the printed wiring board 24 with external instruments. The expression of “under prescribed conditions” herein means the conditions where the temperature detected by the thermistor 25 becomes higher than a predetermined temperature for example. Further, the expression of “under prescribed conditions” herein also means the conditions where the over-charging, over-discharging and over-current of the single cells 21 are detected. The detection of this over-charging is performed against the single cells 21 individually or entirely. In the case where the single cells 21 are to be detected individually, either the voltage of cell may be detected or the potential of the positive electrode or negative electrode may be detected. In the latter case, a lithium electrode is inserted, as a reference electrode, into individual cells 21. In the case of the battery pack shown in FIGS. 5 and 6, a wiring 35 is connected with each of the single cells 21 for detecting the voltage thereof and the signals detected are transmitted, through this wiring 35, to the protection circuit 26.

On all of the sidewalls of the combined battery 23 excepting one sidewall where the negative electrode terminal 6 and the positive electrode terminal 7 are protruded, a protective sheet 36 made of rubber or synthetic resin is disposed, respectively.

The combined battery 23 is housed, together with each of protective sheet 36 and the printed wiring board 24, in a case 37. Namely, the protective sheet 36 is disposed on the opposite inner sidewalls constituting the longer sides of the case 37 and on one inner sidewall constituting one shorter side of the case 37. On the other sidewall constituting the other shorter side of the case 37 is disposed the printed wiring board 24. The combined battery 23 is positioned in a space which is surrounded by the protective sheet 36 and the printed wiring board 24. A cap 38 is attached to the top of the case 37.

By the way, a thermally shrinkable tube may be used in place of the adhesive tape 22 for fixing the combined battery 23. In this case, the protective sheet is disposed on the opposite sidewalls of combined battery 23 and then the thermally shrinkable tube is disposed to surround these protective sheets, after which the thermally shrinkable tube is allowed to thermally shrink, thereby fastening the combined battery 23.

In the embodiment shown in FIGS. 5 and 6, the single cells 21 are electrically connected to each other in series. However, a plurality of single cells may be electrically connected to each other in parallel in order to increase the capacity of a combined battery. Also, a plurality of battery packs, each assembled as described above, may be electrically connected to each other in series or in parallel.

Further, specific features of the battery pack may be optionally modified depending on the end-use thereof. As for the end-use of the battery pack, it can be preferably applied to those where excellent cycle characteristics are desired in large current performance. More specifically, the battery pack can be employed as a power source for digital cameras or as an on-vehicle type power source for two-wheeled or four-wheeled hybrid electric vehicles, for two-wheeled or four-wheeled electric vehicles, or for electric motor cycle. Especially, the battery pack is most suited for use as an on-vehicle power source.

The present invention will be further explained in detail with reference to specific examples which are not intended to limit the scope of the present invention. Incidentally, the identification of the crystalline phase and the estimation of the crystal structure obtained in the reaction were performed by way of powder X-ray diffractometry using Cu—Kα-ray. The measurement of specific surface area was performed based on the BET method. Further, the analysis of the composition of the product was performed by means of the ICP method, thereby confirming whether or not the target product was obtained.

### Synthesis Example 1

Potassium titanate (K₂Ti₄O₉) powder, which was a reagent available in the market, was washed with water at first to remove any impurities and then 5 g of this potassium titanate (K₂Ti₄O₉) powder was placed in a zirconia pot having an inner volume of 100 cm³. Then, zirconia balls each having a diameter of 10 mm were introduced into the pot so as to occupy about ⅓ of the inner volume of the pot. The pot was rotated for two hours at 800 rpm to perform the pulverization of the potassium titanate powder, thereby obtaining a potassium titanate powder having an average particle diameter of 0.8 μm. Then, this pulverized potassium titanate powder was added into a solution of hydrochloric acid of 1M concentration and stirred for 12 hours, thereby exchanging the potassium ion with proton. The suspension thus obtained was excellent in dispersion and found difficult to perform the separation by means of filtration. Therefore, the separation of solvent component from the powder was performed by making use of a centrifugal separator. The proton-exchanged (H₂Ti₄O₉) powder thus obtained was washed with pure water.

Thereafter, this proton-exchanged (H₂Ti₄O₉) powder was stirred in an aqueous solution of lithium chloride to perform the exchange of the proton with lithium ions. In order to reliably perform this exchange with lithium ions, this dispersed liquid was stirred for 48 hours. The resultant dispersion was again subjected to separation using a centrifugal separator and washed with water. Thereafter, the product thus obtained was dried in a vacuum for 12 hours at a temperature of 80° C., thus synthesizing the target lithium titanium composite oxide (Li₂Ti₄O₉) powder. This synthesized powder was then subjected to composition analysis by means of ICP, thus confirming that the exchange of lithium ions was substantially accomplished.

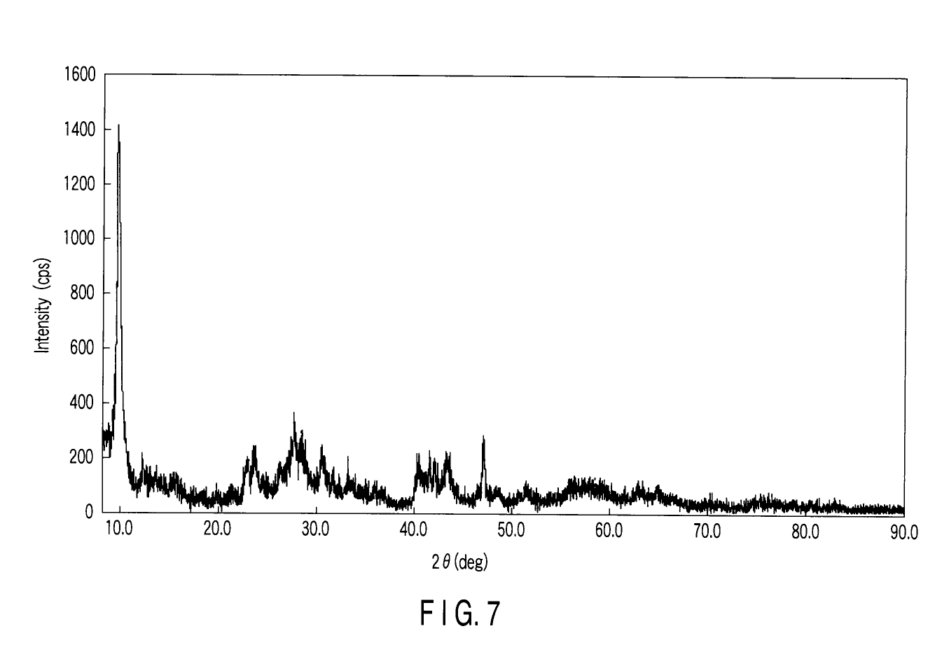

The lithium titanium composite oxide powder thus obtained was then subjected to a powder X-ray diffractometer using Cu—Kα-ray. The powder X-ray diffraction pattern thus obtained is shown in FIG. 7. Incidentally, the measurement conditions were: 3 deg/min. in scanning velocity, 0.2 deg in step width, 40 kV in tube voltage and 20 mA in tube current.

It was possible to confirm from the powder X-ray diffraction pattern shown in FIG. 7 that the lithium titanium composite oxide powder was capable of exhibiting a highest intensity peak of (002) crystal face at 2θ=9.98°±2° and also exhibiting a peak of (402) crystal face at 2θ=27.99° and a peak of (020) crystal face at 2θ=47.93°.

Namely, it was possible to observe three face index peaks which were characteristic of the lithium titanium composite oxide of the present invention. Further, it was also possible to confirm that the half band width of the highest intensity peak of (002) crystal face was 1°/2θ.

Furthermore, when the measurement of specific surface area was performed on the obtained lithium titanium composite oxide powder by the BET method, the specific surface area thereof was found to be 250 m²/g or more.

The results thus obtained are shown in the following Table 1.

### Synthesis Example 2

A solution obtained from the mixing of starting materials consisting of titanium isopropoxide and 2-propanol was prepared. Then, a mixed aqueous solution consisting of ethanol and pure water was slowly added in drop-wise and with stirring to the aforementioned solution to obtain a sol. Then, this sol was allowed to dry at room temperature for 12 hours, and then at 60° C. for 24 hours. Thereafter, the sol was further dried by heating it in an inert gas (Ar) atmosphere at 400° C. for 5 hours, thereby synthesizing a powder.

The powder thus obtained was then subjected to a powder X-ray diffractometer using a Cu—Kα-ray under the same conditions as described in Synthesis example 1. It was possible to confirm from the powder X-ray diffraction pattern thus obtained that this powder was an anatase type titanium oxide (TiO₂). It was impossible to recognize in this powder X-ray diffraction pattern the existence of peaks at the (002) crystal face, (402) crystal face and (020) crystal face.

Further, the measurement of specific surface area was performed on the obtained anatase type titanium oxide powder by the BET method. The specific surface area thus obtained is shown together with the result of measurement by the powder X-ray diffractometer in the following Table 1.

### Synthesis Example 3

Potassium titanate (K₂Ti₄O₉) powder, which was a reagent available in the market, was washed with water at first to remove any impurities and then this potassium titanate powder was added into a solution of hydrochloric acid of 1M concentration without undergoing the pulverization process. The resultant solution was stirred for two hours, thereby exchanging the potassium ions with protons. The suspension thus obtained was poor in dispersion and when the stirring was stopped, the sedimentation of powder was immediately caused to occur. The resultant product was separated by means of filtration to obtain a proton-exchanged (H₂Ti₄O₉) powder, which was then washed with pure water.

Thereafter, this proton-exchanged (H₂Ti₄O₉) powder was stirred in an aqueous solution of lithium chloride to perform the exchange of the protons with lithium ions. In order to reliably perform this exchange with lithium ion, this dispersed liquid was stirred for 48 hours. The resultant dispersion was again subjected to separation using a centrifugal separator and washed with water. Thereafter, the product thus obtained was dried in a vacuum for 12 hours at a temperature of 80° C., thus synthesizing the target lithium titanium composite oxide (Li₂Ti₄O₉) powder. This synthesized powder was then subjected to composition analysis by means of ICP, thus confirming that the exchange of lithium ions was substantially accomplished. Then, 5 g of this powder was placed in a zirconia pot having an inner volume of 100 cm³ and zirconia balls each having a diameter of 10 mm were introduced into the pot so as to occupy about ⅓ of the inner volume of the pot. The pot was rotated for two hours at 800 rpm, thereby obtaining a lithium titanium composite oxide powder having an average particle diameter of 1 μm.

The lithium titanium composite oxide powder thus obtained was then subjected to a powder X-ray diffractometer using a Cu—Kα-ray under the same conditions as described in Synthesis example 1. The 2θ position of each face index peak and the half band width of the highest intensity peak of (002) crystal face, which were determined from the powder X-ray diffraction pattern, are shown in the following Table 1. Further, in this synthesis, a plurality of unknown phases, which are different from the target phase, were detected. The reason for this may be ascribed to the fact that the structure of the oxide powder was caused to change during the treatment using the ball mill, and that, since the ion exchange was performed using coarse particles without the potassium titanate powder being fully pulverized prior to the step of proton exchange, the ion exchange could not be completely accomplished. As a matter of fact, the remaining potassium (K) was detected in the structure as a result of composition analysis by means of ICP, thus confirming that the lithium ion exchange was incomplete.

Further, the measurement of specific surface area was performed on the obtained lithium titanium composite oxide powder by the BET method. The result thus obtained is shown in the following Table 1.

TABLE 1

| | | | | Half band | Specific surface |
|---|---|---|---|---|---|
| | 2θ position of | 2θ position of | 2θ position of | width of (002) | area by BET |
| | (002)face peak | (402)face peak | (020)face peak | face peak | method |
| | (deg) | (deg) | (deg) | (°/2θ) | (m²/g) |
| Synthesis | 9.98 | 27.99 | 47.93 | 1.0 | 258 |
| Example 1 | | | | | |
| Synthesis | Not recognized | Not recognized | Not recognized | — | 36 |
| Example 2 | | | | | |
| Synthesis | 11.42 | 29.288 | 48.45 | 0.3 | 75 |
| Example 3 | | | | | |

As seen from Table 1, in the case of the lithium titanium composite oxide powder obtained from Synthesis example 1 according to the present invention, peaks were recognized at the (002) crystal face, (402) crystal face and (020) crystal face as a result of the measurement by the powder X-ray diffractometer using Cu—Kα-ray, and the half band width of the highest intensity peak of (002) crystal face was 1°/2θ, falling within the range of 0.5°/2θ to 3°/2θ. Furthermore, the specific surface area of the lithium titanium composite oxide powder as measured by the BET method was found to be 200 m²/g or more, thus indicating a high value.

### Example 1 and Comparative Examples 1 and 2

### Manufacture of Electrochemical Measurement Cell

10% by weight of polytetrafluoroethylene was added as a binder to each of the powders obtained in Synthesis examples 1 to 3 and the resultant mixtures were respectively molded to manufacture three kinds of electrodes. Incidentally, in the case of the electrode of Comparative Example 1 containing the powder of Synthesis example 2, 30% by weight of acetylene black was further added as a conductivity-assisting agent prior to the molding step. Then, an electrolyte was poured into a glass case, thereby immersing the metallic lithium foils used as each of electrodes and counter electrodes in the electrolyte, thus assembling three kinds of electrochemical measurement cells. The electrolyte was used a non-aqueous electrolyte in which lithium hexafluorophosphate was dissolved in a propylene carbonate solvent at a concentration of 1M.

In the case of the electrochemical measurement cell of this kind, since metallic lithium is used as a counter electrode, the electric potential of each of the electrodes are noble to the counter electrode. Because of this, the direction of charging/discharging becomes opposite to the case where each of the electrodes is employed as a negative electrode. In order to avoid any confusion, the direction in which lithium ions are inserted into each of the electrodes will be called charging, and the direction in which lithium ions are desorbed will be called discharging, thus unifying the naming.

### Assessments of Charge/Discharge Capacity

Each of the electrochemical measurement cells of Example 1 and Comparative Examples 1 and 2 was made an assessment of charging/discharging curve. The charge/discharge tests of these measurement cells were performed under the conditions in which the charging/discharging was performed at an electric potential range of 1.0V to 2.5V based on metallic lithium electrode and at room temperature and the charge/discharge current values were set to 0.5 mA/cm².

The discharge capacity of each of the electrochemical measurement cells of Example 1 and Comparative Examples 1 and 2 is shown in the following Table 2 as a discharge capacity ratio in comparison with the discharge capacity (1.0) of Comparative Example 1.

### Assessments of Discharging Rate Characteristics

By making use of the electrochemical measurement cells of Example 1 and Comparative Examples 1 and 2, the discharging of cell was performed at an electric potential range of 1.0V to 2.5V based on metallic lithium electrode and at room temperature. In this case, the charge/discharge current value was increased stepwise, i.e., 0.5 mA/cm², 1.0 mA/cm² and 3.0 mA/cm², thereby investigating the discharge capacity retention ratio on these occasions. The discharge capacity retention rates thus obtained are shown in the following Table 2. The discharge capacity retention rate is indicated based on the value (100%) at 0.5 mA/cm².

TABLE 2

| | | | Discharge capacity | | |
|---|---|---|---|---|---|
| | Active | Discharge | retention rate (%) | | |
| | material of | capacity | 0.5 | 1.0 | 3.0 |
| | electrode | ratio | mA/cm² | mA/cm² | mA/cm² |
| Example 1 | Synthesis | 1.73 | 100 | 84 | 71 |
| | Example 1 | | | | |
| Comparative | Synthesis | 1.00 | 100 | 61 | 47 |
| Example 1 | Example 2 | | | | |
| Comparative | Synthesis | 0.82 | 100 | 72 | 65 |
| Example 2 | Example 3 | | | | |

As seen from Table 2, in the case of the measurement cell of Example 1 containing the lithium titanium composite oxide powder, which was obtained from Synthesis example 1 and exhibited specific face index peaks and specific half band width in the measurement by the powder X-ray diffractometer, the charge/discharge capacity thereof was not less than 1.7 times as high as that of the measurement cell of Comparative Example 1.

On the other hand, in the case of the measurement cell of Comparative Example 2 containing the lithium titanium composite oxide powder, which was obtained from Synthesis example 3, the charge/discharge capacity thereof was found inferior as compared even with that of the measurement cell of Comparative Example 1 due to the influence of an impurity present in the powder thereof.

From these results, it was possible to confirm that the lithium titanium composite oxide (Li₂Ti₄O₉) obtained in Synthesis example 1 of the present invention was capable of exhibiting a high capacity.

Further, it will be recognized that the measurement cell of Example 1 containing the lithium titanium composite oxide powder, which was obtained from Synthesis example 1, was suppressed in the decrease of capacity compared with that of the measurement cells of Comparative Examples 1 and 2 at which a large discharge current was flowed. It will be recognized from these results that the lithium titanium composite oxide powder obtained from Synthesis example 1 and exhibiting specific face index peaks and specific half band width was capable of exhibiting more excellent quick charge/discharge characteristics as compared with the active materials obtained in Synthesis Examples 2 and 3 and used in the measurement cells of Comparative Examples 1 and 2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A negative electrode active material for a non-aqueous electrolyte battery, which comprises lithium titanium composite oxide represented by a general formula of: Li₂₊ₓTi₄O₉ (wherein x is 0≦x≦4), the lithium titanium composite oxide being exhibited a highest intensity peak of (002) crystal face at 2θ=10°±2°, a peak of (402) crystal face at 2θ=30°±2° and a peak of (020) crystal face at 2θ=48°±2° as measured by a powder X-ray diffractometer using Cu—Kα-ray source, and a half band width of the highest intensity peak being 0.5°/2θ to 3°/2θ.

2. The negative electrode active material according to claim 1, wherein the half band width of the highest intensity peak is 1°/2θ to 2°/2θ.

3. The negative electrode active material according to claim 1, wherein the lithium titanium composite oxide has a specific surface area of 200 m²/g to 400 m²/g as measured by a BET method.

4. A method of manufacturing a negative electrode active material for a non-aqueous electrolyte battery, which comprises:
pulverizing potassium titanate to obtain potassium titanate powder having an average particle diameter of 0.1 to 5 μm;
subjecting the potassium titanate powder to a reaction with an acid to exchange potassium ion with proton, thereby producing a proton-exchanged powder; and
subjecting the proton-exchanged powder to a reaction with a lithium compound to exchange the proton with lithium, thereby producing lithium titanium composite oxide represented by a general formula of:
Li₂₊ₓTi₄O₉ (wherein x is 0≦x≦4), the lithium titanium composite oxide being exhibited a highest intensity peak of (002) crystal face at 2θ=10°±2°, a peak of (402) crystal face at 2θ=30°±2° and a peak of (020) crystal face at 2θ=48°±2° as measured by a powder X-ray diffractometer using Cu—Kα-ray source, and a half band width of the highest intensity peak being 0.5°/2θ to 3°/20θ.

5. The method according to claim 4, wherein the potassium titanate powder obtained by pulverizing the potassium titanate has an average particle diameter of 0.1 to 1 μm.

6. The method according to claim 4, wherein the acid is hydrochloric acid and the lithium compound is lithium chloride or lithium hydroxide.

7. A non-aqueous electrolyte battery comprising:
a positive electrode which is capable of absorbing and desorbing lithium;
a negative electrode comprising an active material containing lithium titanium composite oxide represented by a general formula of: Li₂₊ₓTi₄O₉ (wherein x is 0≦x≦4), the lithium titanium composite oxide being exhibited a highest intensity peak of (002) crystal face at 2θ=10°±2°, a peak of (402) crystal face at 2θ=30°±2° and a peak of (020) crystal face at 2θ=48°±2° as measured by a powder X-ray diffractometer using Cu—Kα-ray source, and a half band width of the highest intensity peak being 0.5°/2θ to 3°/2θ; and
a non-aqueous electrolyte.

8. The battery according to claim 7, wherein the half band width of the highest intensity peak exhibited the lithium titanium composite oxide is 1°/2θ to 2°/2θ.

9. The battery according to claim 7, wherein the lithium titanium composite oxide has a specific surface area of 200 m²/g to 400 m²/g as measured by a BET method.
